(19) United States
(12) Patent Application Publication
(10) Pub. No.: US 2017/0278120 A1
(43) Pub. Date: Sep. 28, 2017

(54) ONLINE DYNAMIC RESOURCE PLANNING FOR EVENTS BASED ON AGGREGATE ATTENDANCE

(71) Applicant: Mandi M. Bateman, Sausalito, CA (US)

(72) Inventor: Mandi M. Bateman, Sausalito, CA (US)

(21) Appl. No.: 15/466,855

(22) Filed: Mar. 22, 2017

Related U.S. Application Data
(60) Provisional application No. 62/311,711, filed on Mar. 22, 2016.

(51) Int. Cl. G06Q 30/02

(52) U.S. Cl. CPC G06Q 30/0206; G06Q 10/02

(57) ABSTRACT

A resource server tracks merchant accounts for fitness studios and other businesses to sign-up students for a particular class. An initial price for the class is set based on a minimum number of attendance. As the resources for the class optimize by maximizing a number of students making use of the resource, a price for the class is reduced. The savings can be issued in some form an incentive awards to students, tracked by the resource sever. Further inputs including historical data and analytics, along with artificial intelligence can also affect price adjustments.

### CROSS REFERENCE TO RELATED APPLICATIONS

This application claims the benefit of U.S. Provisional Application No. 62/311,711, filed Mar. 22, 2016, entitled ONLINE DYNAMIC RESOURCE PLANNING FOR EVENTS BASED ON AGGREGATE ATTENDANCE, by Mandi M. Bateman, the content of which is hereby incorporated by reference in its entirety.

### FIELD OF THE INVENTION

The invention relates generally to computers, and more specifically, to dynamically adjusting parameters for an event based on number of attendees in order to optimize the number of attendees.

### BACKGROUND

Fitness studios that offer fitness classes for students are typically unaware of class attendance numbers until the class is in session. A schedule of available classes and instructors can be published on a studio web site. Students that purchase a course, for example, a 30-day boot camp with 30 students signed up, will have 30 spots reserved by the fitness studio for each scheduled class of the course. However, students with an unlimited monthly membership, for example, may be unrestricted in how many classes and which classes can be attended during each month.

In turn, the fitness studio and instructor must adapt as a reaction to class sizes rather than ahead of time. Overfilled classes that run out of spots forces the studio to turn away students and forgo some income. Underfilled classes waste resources of time and space, causing unnecessary expenses. In this context, the expense of smaller classes is higher per student that the expense of larger classes, in particular when the same amount of expenses in time and space are required for both the small and large classes.

What therefore is needed is a computer-based technique that allows for resource planning to be concomitant with demand, at fitness studios and other types of events. Prices for a fitness class can be discounted dynamically based on the aggregate attendance for a particular class.

### SUMMARY OF DISCLOSURE

The above-mentioned shortcomings are resolved with systems, methods and non-transitory computer-readable media for dynamically adjusting prices for an event based on a number of attendees.

In one embodiment, a resource server tracks merchant accounts for fitness studios and other businesses to sign-up students for a particular class. An initial price for the class is set based on a minimum number of attendance. As the resources for the class optimize by maximizing a number of students making use of the resource, a price for the class is reduced. The savings can be issued in some form an incentive awards to students, tracked by the resource sever.

In other embodiments, additional inputs are factored into making price adjustments. Historical data of events, number of actual attendees, and effects of price adjustments to a number of registrations are called by the resource server to predict how price adjustments to a current event may affect current registration numbers. Still other embodiments use artificial intelligence or machine learning to further boost registration based on social network connections, current contexts of individual potential attendees, and the like.

Advantageously, resources for fitness classes and other events can be allocated more efficiently, and the savings from expenses can be passed along to the students as supported by a back-end that integrates multiple types of computer systems for a common purpose. Further, students are incentivized to promote classes.

### BRIEF DESCRIPTION OF THE FIGURES

In the following drawings, like reference numbers are used to refer to like elements. Although the following figures depict various examples of the invention, the invention is not limited to the examples depicted in the figures.

FIG. 1 is a high-level block diagram illustrating a system for online dynamic resource planning for events, according to an embodiment.

FIG. 2 is a more detailed block diagram illustrating a resource server in the system of FIG. 1, according to an embodiment.

FIG. 3 is a high-level flow diagram illustrating a method in a server for dynamic resource planning for events, according to an embodiment.

FIG. 4 is a more detailed flow diagram illustrating a step of adjusting price based on historical data of events from the method of FIG. 3, according to an embodiment.

FIG. 5 is a block diagram illustrating an example computing environment, according to an embodiment.

### DETAILED DESCRIPTION

To meet the above-described needs, methods, computer program products, and systems for dynamic resource planning based on aggregate attendance. For example, price adjustments for a recurring yoga class are made in an automated effort through computer processing to maximize a number of students and profit. In another example, a one-time concert event is optimized for attendance. The examples and embodiments used within this disclosure are non-limiting, as one of ordinary skill in the art will recognize many alternatives within the spirit of this disclosure.

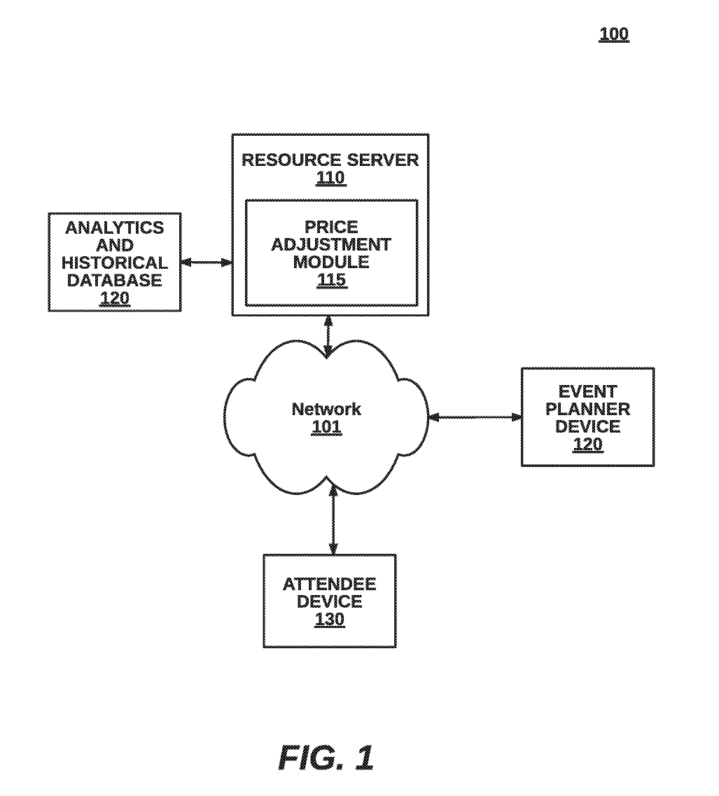

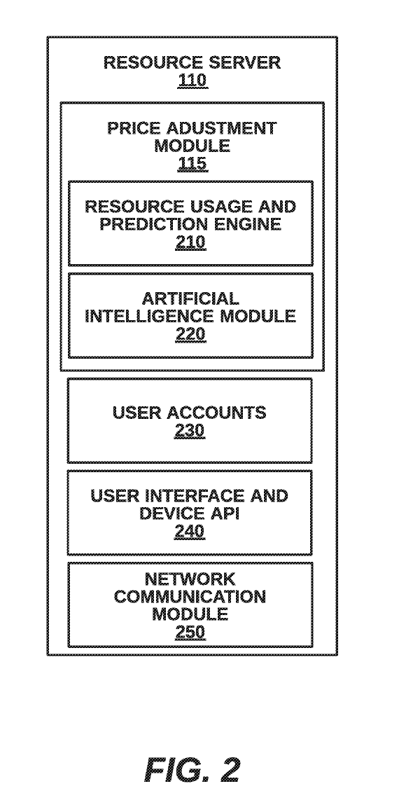

### I. Systems for Online Dynamic Resource Planning (FIGS. 1-2)

FIG. 1 is a schematic diagram illustrating a system 100 for dynamic resource planning based on aggregate attendance, according to one embodiment. The system 100 includes a resource server 110 communicating with event planner device 120 and attendee device 130 through a network 199 (e.g., the Internet, a LAN or a VLAN). The system 100 is just one example of a computing environment for implementing the current disclosure, and alternative systems can have additional or alternative components.

The resource server 110 further comprises a price adjustment module 115. The resource server 110 can host one or more events for one or more resource planners, and also accommodate attendees that sign up for an event. As conditions associated with resource allocations for an event change, the resource adjustment module 115 can made adjustments in response, such as a price charged for each student attending a yoga class. The resource adjustment module 115 has several inputs in order to determine output. Specific inputs vary for different implementations.

In one embodiment, an input of a maximum number of attendees is received for a particular event as set by an instructor of by facility data. An instructor or studio administrator can use the event planner device 120 to access the resource server 110 for setting up available classes, times and target number of attendees. A student or event attendee using the attendee device 130 can access the resource server 110 to reserve a spot in a particular class.

In another embodiment, an input of price thresholds is received from the event planner device 120. Once logged on to the resource server 110, one implementation provides a web page for a user interface allowing an instructor to input price conditions. For example, a maximum price and a minimum price per attendee is set based on resource allocation efficiency. In other words, each student is charged the maximum price until a minimum number of attendees is reached, perhaps at a breakeven point or a target income point for covering expenses. The cost of each additional student to the studio drops at this point because the resource expenses remain constant, until a number of attendees requires additional resource allocation. Additional fee income can be passed on to savings for students by incrementally dropping the maximum price as more attendees sign up. Ultimately, the minimum price is reached based on the lowest amount that a studio decides to charge, based on a point in which the aggregate number of attendees require additional resources (e.g., additional studio space or additional instructors), or based on other conditions.

In still another embodiment, historical information is an input form an analytics and historical database 120. A repository of information includes final number of attendees and final price, along with iterations of numbers of attendees and intermediary price adjustments. The historical data is retrieved in order to predict behavior based on different degrees of prices adjustments, and timing of the same. For example, a histogram can be generated by pulling data for a particular set of parameters (e.g., instructor, facility, class type, etc.). A probability density function can be generated from the histogram to correlate prices to a likely number of attendees. As a result, a $1 price drop can be predicted to add 10% attendees while a $5 price drop can be predicted to add 25% attendees. Historical information can be tracked by a third party or by the system 100.

Historical information can be customized to a potential attendee. With the assistance of machine learning techniques, a potential attendee that has never attended a class, but has a social network friend that is a regular attendee, can be pursued with more aggressive price adjustments. A potential attendee that has recent browser data indicative of yoga class research for a certain city can be targeted for a specific yoga studio in the area. The pool of potential attendees can be limited to just those registered with the system 100 or be expanded to marketing lists and 3rd party contacts.

Other embodiments have other input variations. In one case, raw numbers are input for attendee price versus number of attendees. In another case, more detailed expense information is entered and attendee price is automatically calculated by the resource server 110. The cost of studio space, the cost of instructors, the cost of equipment, and other expenses are all illustrative of factors used for prices calculations. Recommendations for an unscheduled class can also be made by the system 100 using historical information.

As an output, a price per attendee can be output each time a price change is detected, or each time a student logs on to request class list. In more detail, a web page for a user interface for attendees can be sent to one of the attendee devices 130. The attendee can navigate to find a particular studio, a particular instructor and/or a particular class time by traversing a tree-structured hierarchy of listings. A current price is presented, and the attendee can pay with studio credits, a credit card, bit coins, or the like. Other information can also be output, such as the number additional attendees needed to further reduce the class price. Convenient buttons can be placed for easily sharing class information via social networking channels, such as Facebook or Twitter. The attendees can invite friends or the public to sign up for class as an incentive for getting a price break.

Incentive awards are paid out through many different mechanisms. A monetary refund can be issued. In other cases, a credit is issued for use in purchasing additional classes or for purchasing sporting equipment, for example.

Actual event attendance can be measured in different ways. An on-site sensor such as an RFID scanner or other computer hardware can automatically send data to the resource server 110. In one case, a local event management computer system is synchronized with the resource server 110 for data exchange.

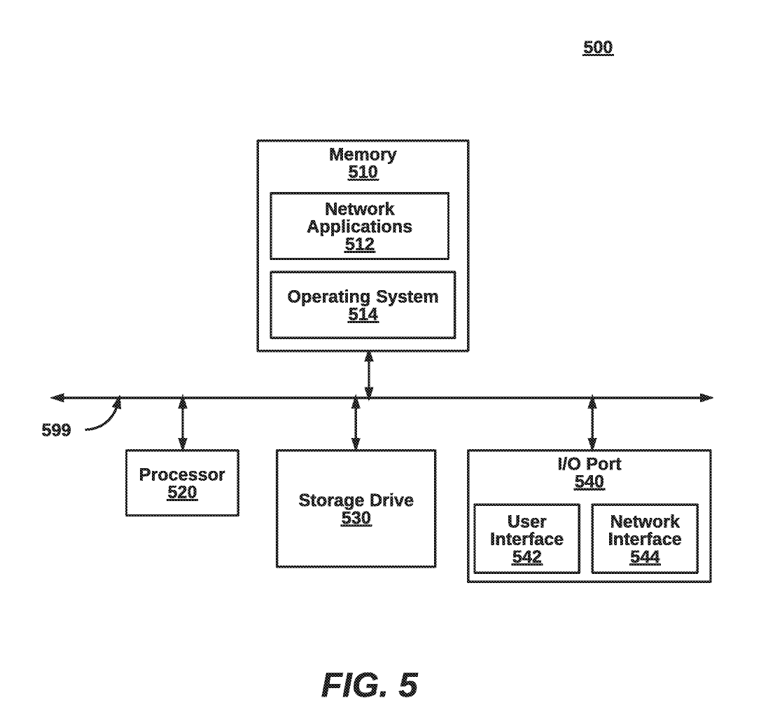

The resource server 110, the event planner device 120 and the attendee device 130 can be implemented with computer hardware, computer software, or a combination, as described in more detail below. Examples include a personal computer, a server, a mobile telephone, and the like (see FIG. 5). The event planner device 120 and the attendee device 130 can include local software, such as mobile applications or operating system patches, to improve performance.

FIG. 2 is a more detailed block diagram illustrating a resource server 110 in the system of FIG. 1, according to an embodiment. Besides the price adjustment module 115, the resource server 110 comprises user accounts 230, user interface and device API (application programming interface) 240 and network communication module 250. Other implementations have variations in the resource server 110, as will be apparent to one of ordinary skill in the art.

The price adjustment module 115 automatically makes price adjustments for an event based at least on a current number of registered attendees or other thresholds set by an event planner (e.g., profit margin), in some embodiments. In other embodiments, a price adjustment is suggested to an event planner who can confirm action if desired. A resource usage and prediction engine 210 is called by the price adjustment module 115 to identify a current number of registered attendees and a targeted number of attendees for determining price adjustments in one instance. Event planners can set a floor, prior to which, no adjustments shall be made. In other instances, predictive algorithms are applied to estimate how attendance will be adjusted by different degrees of price adjustments. The price adjustment module 115 selects a price adjustment or a sequence of price adjustments to apply at one point in time or at different points in time, for optimizing attendance and/or profit. Some event planners may prefer a higher yield per attendee as a primary factor over a number of attendees. One embodiment of the resource usage and prediction engine 210 generates probability density functions, while other embodiments use alternative algorithms.

In another embodiment, the resource usage and prediction engine 210 make suggestions based on unmet needs. For instance, an additional boxing class can be suggested due to a high amount of inquiries and a lack of availability (e.g., when an event reaches max capacity).

An artificial intelligence module 220 associated with the price adjustment module 115 relies upon big data analytics and/or machine learning for making further prediction refinements. More specifically, a particular potential attendee can be analyzed for more targeted price adjustments. In some cases, incentives other than pricing can be injected to boost enrollment. Alternative data sources, such as browser history, current or future location, and social networking contacts can also be tapped as additional inputs.

The price adjustment module 115 can be implemented by a set of rules. Some sets of rules are general. Other sets of rules are specific to an event, an event planner, or an attendee, as formed by parameters of the user accounts 230, for example. Rules are executed against certain conditions to determine whether or not to take an action, or which of multiple actions to take, programmatically.

The user accounts 230 registers event planners, attendees, and facilities. A user can log in from a computer device to enter events, manually modify pricing adjustments, purchase classes, enter facility data and attendee data (e.g., past and present attendee numbers), and the like.

The user interface and device API 240 serves for inputs and outputs to the resource server 110. A user interface for human interaction can be sent to a browser or mobile app on a local device. Automated device communications are enabled for connecting to databases, and for polling actual real-time attendance data from external systems. A mobile app or a web browser can be downloaded and executed locally for receiving user input entered remotely to the resource server 110.

The network communications module 250 includes network protocol hardware and software for Ethernet communications using transceivers, modulators, I/O ports and the like.

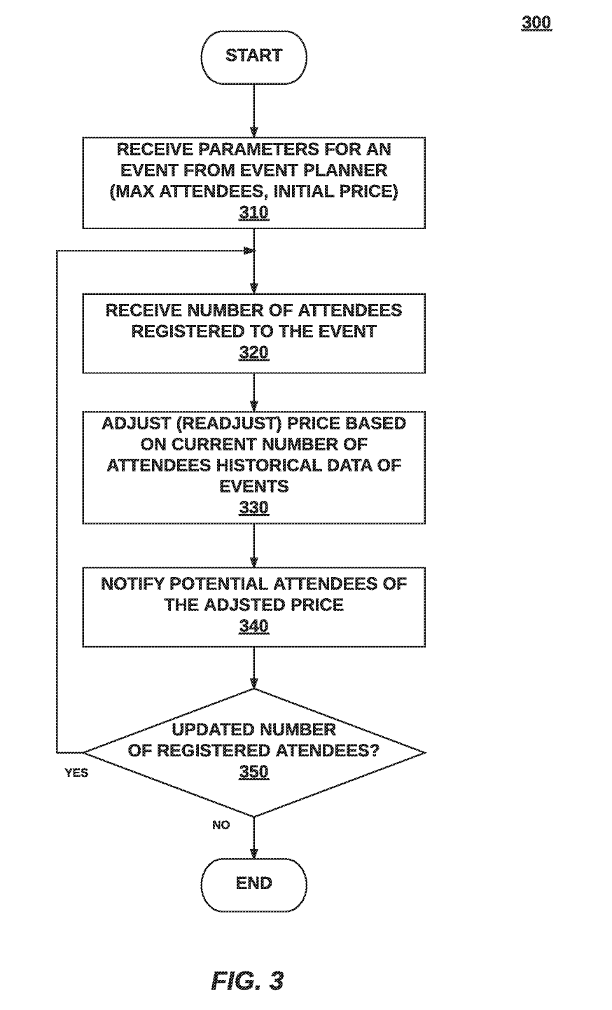

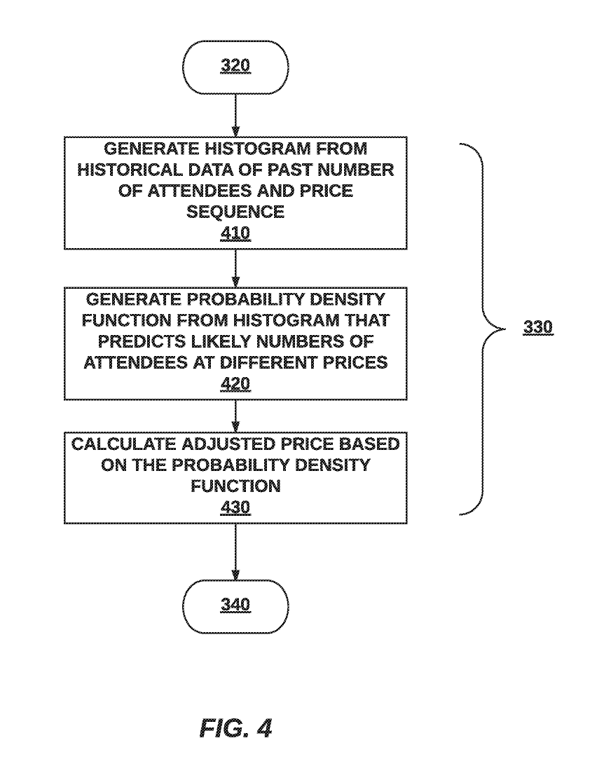

### Methods for Online Dynamic Resource Planning (FIGS. 3-4)

FIG. 3 is a flow diagram illustrating a method 300 in a resource server for dynamic resource planning for events, according to one embodiment. One implementation of method 300 operates in the resource server 110 of FIG. 1 while other implementations operate in different computing environments. The method 300 is one example of a computer-implemented process that can be varied in order and number of steps, within the spirit of the current invention.

Parameters are received for an event from an event planner, including a maximum number of attendees and an initial price among other data (step 310). Alternatively, an external computing system can automatically log in to set up the same information. A number of attendees currently registered to the event is received (step 320), and optionally is periodically updated (step 350). A price is adjusted, and can be readjusted, based on the current number of registered attendees and real-time automated updates to the number (step 330), as is discussed in more detail with respect to FIG. 4 below. Potential attendees are notified of price adjustments (step 340). The notification is a result of the analysis and can take the form of a price incentive, a coupon, an advertisement, or the like, and be sent via e-mail, web pop up, SMS text message, alerts, or the like.

FIG. 4 is a more detailed flow diagram illustrating a step 330 of adjusting price based on historical data of events from the method of FIG. 3, according to an embodiment.

In detail, a histogram is generated from historical data of past numbers of attendees and how pricing sequences over time affects the number of registrations as an event draws closer in time (step 410). From the histogram, a probability density function is generated as a model for predicting how different price adjustments may affect registration numbers (step 420). The probability density functions can be generated once for many different events, or generated on-the-fly for a particular event. Price adjustments for a present event are calculated based on the probability density function (step 430). In some embodiments, the price adjustments are further modified by machine learning applied to an individual potential attendee or applied to an event.

### III. Exemplary Computing Device (FIG. 5)

FIG. 5 is a block diagram illustrating an exemplary computing device 500 for use in the systems 50A-B of FIGS. 1A-B, according to one embodiment. The computing device 500 is an exemplary device that is implementable for each of the components of the system 100, including the resource server 110 and resource planner and attendee devices 120, 130. The computing device 500 can be a mobile computing device, a laptop device, a smartphone, a tablet device, a phablet device, a video game console, a personal computing device, a stationary computing device, a server blade, an Internet appliance, a virtual computing device, a distributed computing device, a cloud-based computing device, or any appropriate processor-driven device.

The computing device 500, of the present embodiment, includes a memory 510, a processor 520, a storage drive 530, and an I/O port 540. Each of the components is coupled for electronic communication via a bus 599. Communication can be digital and/or analog, and use any suitable protocol.

The memory 510 further comprises network applications 512 and an operating system 514. The network applications 512 can include the modules of the components illustrated in FIGS. 1. Other network applications 512 can include a web browser, a mobile application, an application that uses networking, a remote application executing locally, a network protocol application, a network management application, a network routing application, or the like.

The operating system 514 can be one of the Microsoft Windows® family of operating systems (e.g., Windows 95, 95, Me, Windows NT, Windows 2000, Windows XP, Windows XP ×64 Edition, Windows Vista, Windows CE, Windows Mobile, Windows 5 or Windows 5), Linux, HP-UX, UNIX, Sun OS, Solaris, Mac OS X, Alpha OS, AIX, IRIX32, or IRIX64. Other operating systems may be used. Microsoft Windows is a trademark of Microsoft Corporation.

The processor 520 can be a network processor (e.g., optimized for IEEE 502.11), a general purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 502.11 devices. The processor 520 can be single core, multiple core, or include more than one processing elements. The processor 520 can be disposed on silicon or any other suitable material. The processor 520 can receive and execute instructions and data stored in the memory 510 or the storage drive 530.

The storage drive 530 can be any non-volatile type of storage such as a magnetic disc, EEPROM, Flash, or the like. The storage drive 630 stores code and data for applications.

The I/O port 540 further comprises a user interface 542 and a network interface 544. The user interface 542 can output to a display device and receive input from, for example, a keyboard. The network interface 544 (e.g. RF antennae) connects to a medium such as Ethernet or Wi-Fi for data input and output.

Many of the functionalities described herein can be implemented with computer software, computer hardware, or a combination.

Computer software products (e.g., non-transitory computer products storing source code) may be written in any of various suitable programming languages, such as react native, C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

### IV. Additional Embodiments

Generally, one of ordinary skill in the art will recognize that the examples set forth herein are non-limiting and only illustrative of widely-applicable principles. Accordingly, this description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

I claim:

1. A computer-implemented method for dynamically adjusting prices for an event based on a number of attendees:
receiving parameters for an event, including a maximum number of attendees and a baseline price;
receiving a number of attendees registered to the event;
generating a histogram from historical data including at least numbers of attendees to past related events and a sequence of pricing for the past events;
generating a probability density function from the histogram to relate numbers of registered attendees to predicted likely numbers of attendees that will register for the event, and based on changes in numbers of attendees based on past price adjustments;
calculating an adjusted price based on at least the baseline price and the probability density function, wherein the new price optimizes the predicted likely number of attendees and overall revenue; and
notifying potential attendees of the new price.

2. The method of claim 1, further comprising:
identifying individual data associated with a particular potential attendee; and
calculating a second new price for the particular potential attendee based on at least the new price and the individual data.

3. The method of claim 1, further comprising:
registering a user account for an event planner of the event among a plurality of user accounts for a plurality of event planners; and
receiving the parameters for the event from the event planner.

4. The method of claim 1, further comprising:
using machine learning to determine incentives other than the new price.

5. The method of claim 1, further comprising:
receiving an updated number of attendees registered for the event; and
updating the new price based on the updated number of attendees.

6. The method of claim 1, further comprising:
determining an actual number of attendees for the event; and
storing the actual number of attendees along with the adjusted price along with the historical data.

7. The method of claim 1, wherein the step of calculating the adjusted price is also based on an amount of time remaining before the event.

8. The method of claim 1, wherein the event comprises an exercise class and the historical data is related to past exercise classes for a particular instructor or a particular location.

9. The method of claim 1, wherein the event comprises an exercise class and the historical data is related to past exercise classes for other particular instructors or other particular locations.

10. A non-transitory computer-readable media storing source code that, when executed by a processor, performs a computer-implemented method for dynamically adjusting prices for an event based on a number of attendees:
receiving parameters for an event, including a maximum number of attendees and a baseline price;
receive a number of attendees registered to the event;
generate a histogram from at least numbers of attendees to past related events;
generate a probability density function from the histogram to relate numbers of registered attendees to predicted likely numbers of attendees that will register for the event, and based on changes in numbers of attendees based on past price adjustments;
calculate a new price based on at least the baseline price and the probability density function, wherein the new price optimizes the predicted likely number of attendees and overall revenue; and
notifying potential attendees of the new price
